(19) United States
(12) Patent Application Publication
(10) Pub. No.: US 2025/0064236 A1
(43) Pub. Date: Feb. 27, 2025

(54) ADJUSTABLE PILLOW

(71) Applicant: Purple Innovation, LLC, Lehi, UT (US)

(72) Inventors: Janae Lois Pettit, Pleasant Grove, UT (US); Devin Dorius, Eagle Mountain, UT (US); Caulin G. Tanner, Salt Lake City, UT (US)

(21) Appl. No.: 18/812,940

(22) Filed: Aug. 22, 2024

Related U.S. Application Data
(60) Provisional application No. 63/533,939, filed on Aug. 22, 2023.

(51) Int. Cl. A47G 9/10

(52) U.S. Cl. CPC A47G 9/1081; A47G 2009/1018

(57) ABSTRACT

This disclosure relates generally to cushioning elements and adjustable cushioning elements, such as adjustable pillows. An adjustable cushion may include a casing having an opening with a closure and a fill material contained within at least one compartment of the casing. The fill material is accessible via the opening. The fill material may include a responsive foam and a fiber fill mixed together. The fill material may be cut into a plurality of various shapes. The fiber fill may increase a comfort of the responsive foam and/or cause the plurality of shapes of the responsive foam to cling to each other. A firmness and/or loft (i.e., height) and comfort level of the adjustable cushion can be adjusted by adding or removing the fill material to the casing via the opening.

### CROSS-REFERENCE TO RELATED APPLICATION

A claim for priority to the Aug. 22, 2023 filing date of U.S. Provisional Patent Application No. 63/533,939, titled ADJUSTABLE PILLOW (“the 939” Provisional Application”), is hereby made. The entire disclosure of the '939 Provisional Application is hereby incorporated herein.

### TECHNICAL FIELD

This disclosure relates generally to adjustable cushions, including, without limitation, pillows and, more specifically, to adjustable cushions that have an adjustable firmness and/or an adjustable loft (i.e., height). A firmness and/or loft of all of the adjustable cushion may be generally adjusted, a firmness and/or loft of a portion (e.g., an edge portion, etc.) of the adjustable cushion may be locally adjusted, or a firmness and/or loft of the adjustable cushion may be adjusted generally and locally. Different regions of the adjustable cushion may have different firmnesses and/or lofts. This disclosure also relates to systems that include adjustable cushioning elements and secondary cushions that hold fill material that has been removed from and/or may be added to the adjustable cushions, as well as to methods for adjusting the firmness and/or loft of a cushion.

### RELATED ART

Cushioning elements, such as pillows, mattress, seat cushions, etc., are typically not adjustable. Generally, a hardness or firmness of any given cushioning element (e.g., pillow, mattress, cushion, etc.) is determined when the cushioning element is manufactured. As such, consumers must have an idea of how firm or soft they want the cushioning element to be prior to purchasing the cushioning element.

One good example of this is a mattress. Mattresses are typically designed with either a firm sleeper or a soft sleeper in mind; usually, a mattress is not designed for both types of sleepers. This is because there are competing calls to make when deciding how firm to make a mattress. What is desirable for a firm sleeper is usually the opposite of what is desirable for a soft sleeper. Even with a cushioning element as large as a mattress, it can be difficult to provide zones of differing firmness without compromising the overall experience for a user.

With smaller cushioning elements, such as pillows, space constraints make it even more difficult to provide zones of differing firmness. An added problem for pillows is that, during use, the fill material contained within the pillow undesirably compresses such that a height and firmness of the pillow is lost, squishes to one portion of the pillow or another such that the fill material is not directly under the sleeper's head and further adding to the loss of height or firmness, or a combination of both.

### SUMMARY

Disclosed are adjustable cushions, such as adjustable pillows. In various aspects, an adjustable cushion may include a casing and a fill material within the casing.

The fill material includes particles or pieces of a cushioning material. Optionally, the fill material may comprise a responsive foam and a fiber fill mixed into the responsive foam. The fill material may be cut into a plurality of various shapes. The fiber fill may increase a comfort of the responsive foam and/or cause the plurality of shapes of the responsive foam to cling to each other.

The casing may have an opening and optionally include a closure for the opening. One or more compartments within the casing may be accessible through the opening, providing access to the fill material and enabling the addition of fill material to or the removal of fill material from the one or more containers. The addition of fill material to a container and the removal of fill material from the container may adjust a firmness and/or a loft (i.e., height) of the adjustable cushion or a portion of the adjustable cushion.

The one or more compartments of the casing may comprise a primary compartment, which receives a majority of the fill material and, thus, provides a majority of the cushioning. Optionally, the casing may include one or more secondary compartments, which may provide supplemental cushioning. Without limitation, a secondary compartment may be located adjacent to an edge (e.g., a long edge, a short edge, etc.) of the casing. Such a secondary compartment may have a configuration that, when filled with a fill material, provides additional support for a body part of an individual. In embodiments where the adjustable cushion comprises a pillow, fill material within the primary compartment may cushion an individual's head, while fill material within the secondary compartment may supports the individual's neck.

An adjustable cushioning system may include an adjustable cushion (e.g., a primary pillow, etc.) and a secondary cushion (e.g., a decorative pillow, such as a throw pillow, etc.). The secondary cushion may include a casing with an opening and an optional closure for the opening. The casing of the secondary cushion may receive fill material. A firmness or loft of the adjustable cushion can be adjusted by adding fill material from the secondary cushion to the to or removing fill material from the to the casing via the zippered opening.

Also disclosed are fill materials to be used with disclosed adjustable pillows and/or adjustable pillow systems. In some embodiments, the fill materials include a responsive foam and a fiber fill mixed into or otherwise dispersed throughout the responsive foam. The responsive foam may be cut into a plurality of various shapes. The fiber fill may increase a comfort of the responsive foam and cause the plurality of shapes of the responsive foam to cling to each other.

Methods for cushioning or otherwise supporting at least part of an individual are also disclosed. Such a method may include adjusting a volume of fill material within at least one compartment of a casing for an adjustable cushion. Adjusting the volume of fill material may include adjusting the volume of fill material within a primary compartment of the casing and/or a secondary compartment of the casing. Adjustment of the volume of the fill material may include adding fill material to the at least one compartment; optionally, such fill material may be obtained from a secondary cushion. Adjustment of the volume of the fill material may include removing fill material from the at least one compartment; optionally, such fill material may be stored in a secondary cushion. In some embodiments, the method may also include selecting the fill material to be held within at least one compartment of a casing of an adjustable cushion.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 is a perspective view of an embodiment of an adjustable cushion;

FIGS. 2A-2C are side view of the embodiment of adjustable cushion shown in FIG. 1 adjusted to different lofts, or heights;

FIG. 3 is an exploded view of the embodiment of the adjustable cushion shown in FIG. 1;

FIG. 4 is an exploded view of another embodiment of an adjustable cushion that includes a gel material in a casing of the adjustable cushion;

FIG. 5 is a cross-sectional representation of the embodiment of the adjustable cushion shown in FIG. 4;

FIGS. 6 and 7 are side views of further embodiments of adjustable cushions;

FIG. 8 schematically illustrates an embodiment of a cushioning system that includes an adjustable cushion and a secondary cushion; and

FIG. 9 depicts an embodiment of a filler material that may be used in an adjustable pillow of this disclosure.

### DETAILED DESCRIPTION

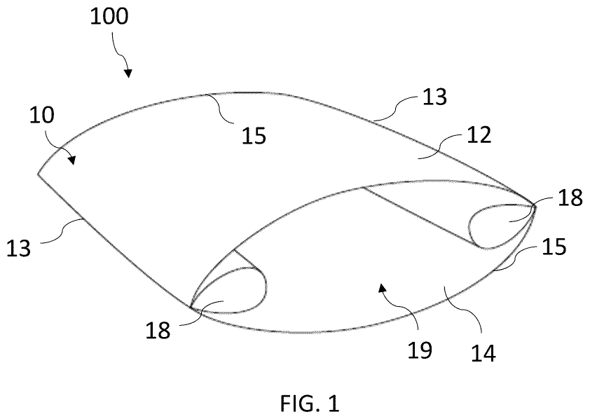

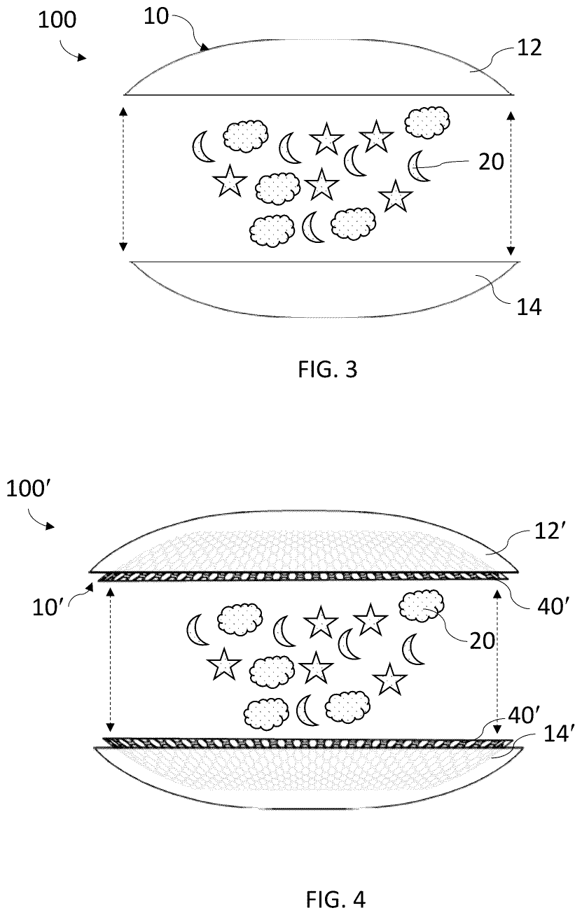

FIG. 1 illustrates an embodiment of an adjustable cushion 100. As depicted, the adjustable cushion 100 may comprise a bed pillow; however, other configurations of adjustable cushions (e.g., seat cushions, body pillows, neck pillows, lumbar supports, etc.) are also within the scope of this disclosure. The adjustable cushion 100 includes a casing 10 having a top 12, a bottom 14, long edges 13, and short edges 15 adjacent and perpendicular to the long edges 13. In some embodiments, the top 12 and bottom 14 define a primary compartment 19, or a pocket or void, for holding a fill material 20 (FIGS. 3, 4, and 9). As discussed more fully hereinafter, the casing 10 may also include one or more additional compartments, or secondary compartments 18 (e.g., neck compartments, etc.).

The primary compartment 19 receives a fill material 20 (FIGS. 3, 4, and 9). Additionally, in some embodiments, one of the short edges 15 includes an opening that may include a closure (e.g., a zipper, etc.) (not illustrated) to provide selective access to the inside of the primary compartment 19. In some embodiments, one of the long edges 13 may include an opening and a closure to provide selective access to the inside of the primary compartment 19. A user of the adjustable cushion 100 can adjust an overall height, or a loft, and/or a firmness of the adjustable cushion 100 by adding fill material 20 to or removing fill material 20 from the primary compartment 19.

The secondary compartments 18 may be accessible from the same opening as the primary compartment 19, or along the opening in the short edge 15, although it is contemplated that the opening can be in a different location on the casing 10. Each secondary compartment 18 may extend the length of one or both of the long edges 13 of the casing 10, although one or more secondary compartments 18 extending along the length of one or more of the short edges 15 of the casing 10 are also contemplated. Each secondary compartment 18 may be tubular in shape. Furthermore, each secondary compartment 18 may share a scam with its corresponding edge (e.g., a long edge 13, short edge 15, etc.) of the casing 10. This shared seam may be a single, a linear, a contiguous, point of contact of the secondary compartment 18 to the casing 10. However, it is contemplated that the secondary compartment 18 may be adhered to the casing 10 in any of a variety of locations as well.

In some embodiments, the one or more secondary compartments 18 (e.g., one or more neck compartments, etc.) are also adjustable through addition or removal of fill material 20. In this way, a height and/or firmness of a portion of the adjustable cushion 100 can be modified. The height and/or firmness of a secondary compartment 18 (e.g., a second firmness of the adjustable cushion 100, etc.) may differ from a height and/or firmness of a primary compartment 19 (e.g., a first firmness of the adjustable cushion 100, etc.).

In some embodiments, the casing 10 is made from a pliable material, such as a fabric, a woven material, or a non-woven material. In some embodiments, the casing 10 is made from a fabric with a degree of stretch (e.g., a spandex-cotton blend, etc.), to accommodate additional fill material 20 being added to or removed from the primary compartment 19 and/or one or more secondary compartments 18 of the adjustable cushion 100.

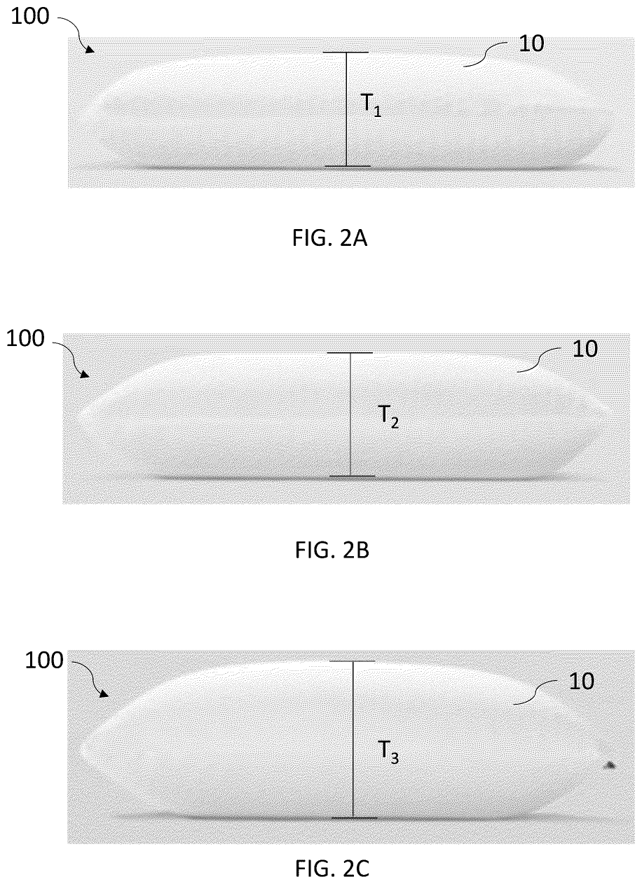

FIGS. 2A-2C illustrate embodiments of configurations for the adjustable cushion 100. The adjustable cushion 100 can be transitioned between each configuration by adding fill material 20 (FIGS. 3, 4, and 9) to or removing fill material 20 from the primary compartment 19 of the casing 10 of the adjustable cushion 100. Specifically, the adjustable cushion 100 has at least three (3) configurations corresponding to differing heights, or lofts, of the adjustable cushion 100. For example, as shown in FIG. 2A, the adjustable cushion 100 can have a first height T₁; as shown in FIG. 2B, the adjustable cushion 100 can have a second height T₂; and, as shown in FIG. 2C, the adjustable cushion 100 can have a third height T₃. T₁ may be less than T₂; T₂ may be less than T₃.

In some embodiments, the first height T₁ can range from about 4.5 inches to 6 inches, such as 5 inches, 5.5 inches, or a height within a range defined by any two of the foregoing values. In some embodiments, the second height T₂ can range from about 5.5 inches to 7 inches, such as 6 inches, 6.5 inches, or a height within a range defined by any two of the foregoing values. In some embodiments, the third height T₃ can range from about 6.5 inches to 8 inches, such as 7 inches, 7.5 inches, or a height within a range defined by any two of the foregoing values.

It will be understood that those ranges defined herein are not intended to be limiting since the height of the adjustable cushion 100 is intended to be adjustable. Those numbers set forth herein may represent standard heights of pillows. A user may choose any of an infinite number of heights by the addition and subtraction of the fill material 20 (FIGS. 3, 4, and 9).

FIG. 3 is an exploded view of the adjustable cushion 100. The adjustable cushion 100 includes a casing 10 and fill material 20. The casing 10 has a top 12 and a bottom 14. The primary compartment 19 (FIG. 1) of the adjustable cushion 100 is defined between the top 12 and bottom 14 of the casing 10. The fill material 20 is disposed between the top 12 and the bottom 14, within the primary compartment 19.

The fill material 20 includes pieces or particles of a cushioning medium. In some embodiments, the fill material 20 is formed into shapes. In some embodiments, the fill material 20 is shredded. In some embodiments, the fill material 20 is a combination of shaped fill material 20 and shredded fill material 20. As described in reference to FIG. 1, the adjustable cushion 100 may include one or more openings, each of which may include a closure (e.g., along a short edge 15, along a long edge 13, etc.) to provide selective access the primary compartment 19 (FIG. 1) and/or a secondary compartment 18 (FIG. 1) and the fill material 20 therein. A user may add or remove fill material 20 in order to adjust a height and/or firmness of the adjustable cushion 100 and/or a portion of the adjustable cushion 100.

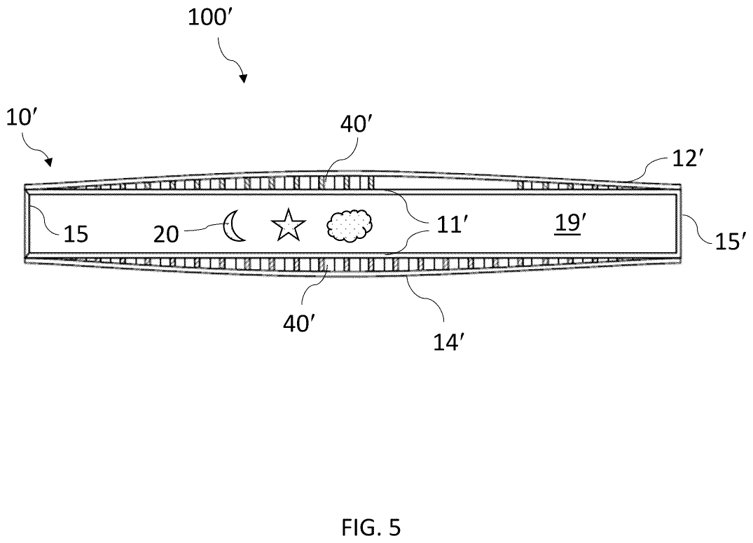

In some embodiments, such as that illustrated by FIGS. 4 and 5, in addition to a top 12′ and a bottom 14′, a casing 10′ of an adjustable cushion may additionally include a layer 40′ of elastomeric material. A first side of the layer 40′ may be positioned adjacent to the top 12′ and/or bottom 14′ of the casing 10′. Optionally, the first side of the layer 40′ may be secured (e.g., adhered, etc.) to the top 12′ and/or bottom 14′ of the casing 10′. As shown in FIG. 5, a second side of the layer 40′, which is opposite from the first side of the layer 40′, may be attached to a pliable sheet 11′ (e.g., a sheet of a fabric, a scrim fabric, etc.). The pliable sheet(s) 11′ may define at least a portion of a primary compartment 19′ within the casing 10′. As illustrated, the casing 10′ includes two layers 40′ of elastomeric material, with one of the layers 40′ sandwiched between the top 12′ of the casing 10′ and the pliable sheet 11′ and the other of the layers 40′ sandwiched between the bottom 14′ of the casing 10′ and the pliable sheet 11′.

A fill material 20 is contained within the primary compartment 19′ of the casing 10′, between the top 12′ and bottom 14′ of the casing 10′ and, in embodiments where the casing 10′ includes two layers 40′ of elastomeric material, between the layers 40′ and any pliable sheets 11′ on the layers 40′. In embodiments where the casing 10′ includes one or more pliable sheets 11′, each pliable sheet 11′ may provide an interface or barrier between a layer 40′ of elastomeric material and the fill material 20. For example, when the layer 40′ is an elastomeric material, the layer 40′ may be sticky or tacky. The presence of the pliable sheet 11′ may prevent the fill material 20 from adhering or sticking to the layer 40′.

In some embodiments, the pliable sheet 11′ is attached to the layer 40′ during manufacturing of the layer 40′. In some embodiments, the layer 40′ may have a mesh or grid structure (e.g., a hexagonal grid, a square grid, a diamond grid, etc.) that provides a cradling effect for a supported body part, which may improve the comfort with which the adjustable cushion 100′ cushions the body part. In some embodiments, the presence of the layer 40′ imparts the casing 10′ with an ability to regulate temperature (e.g., by removing body heat from a portion of an individual's body supported by the layer 40′. In some embodiments, the layer may increase a breathability of the adjustable cushion 100′. Temperature regulation and/or increasing the breathability of the adjustable cushion 100′ may provide users with a cooler and more comfortable cushioning experience. In some embodiments, the layer 40′ may contribute to an overall comfort and/or firmness for the adjustable cushion 100′.

In some embodiments, a thickness of the layer 40′ may range from ⅛ inch to 3 inches. In some embodiments, the layer 40′ is formed from an elastomeric gel material. In some embodiments, the layer 40′ includes a grid of an elastomeric gel material. U.S. Pat. No. 5,994,450, titled GELATINOUS ELASTOMER AND METHODS OF MAKING AND USING THE SAME AND ARTICLES MADE THEREFROM, which issued on Nov. 30, 1999 (“the '450 Patent”), and U.S. Pat. No. 7,964,664, titled GEL WITH WIDE DISTRIBUTION MW IN MID-BLOCK,” which issued on Jun. 21, 2011 (the '644 Patent), describe elastomeric materials that may be used for the layer 40′. The entire disclosures of the '450 Patent and '644 Patent are hereby incorporated herein.

U.S. Patent Application Publication No. US 2020/0390247 A1, the entire disclosure of which is hereby incorporated herein, provides further specifics regarding an embodiment of casing 10′ of the type shown in FIGS. 4 and 5.

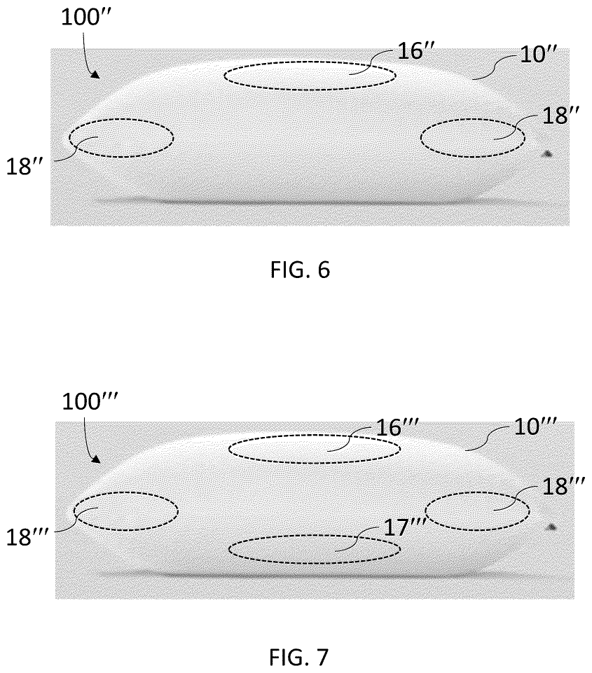

FIGS. 6 and 7 illustrate additional embodiments of adjustable cushions 100″, 100″. The adjustable cushions 100″, 100′″ may include a primary compartment 19″, 19′″ for receiving and holding fill material 20 (FIGS. 3, 4, and 9), as well as one or more secondary compartments 16″, 18″ (FIG. 6), 16′″, 17′″, 18′″ (FIG. 7), which may also receive and hold fill material 20.

As illustrated in FIG. 6, the adjustable pillow 100″ includes neck compartments 18″ and a top compartment 16″. The neck compartments 18″ may be located on or adjacent to opposite edges of the casing. The top compartment 16″ may be centrally or substantially centrally located on the adjustable cushion 100″, at or adjacent to a surface of the adjustable cushion 100″.

As illustrated in FIG. 7, the adjustable pillow 100′″ includes neck compartments 18′″, a top compartment 16″, and a bottom compartment 17″. The top compartment 16′″ and bottom compartment 17″ may be centrally or substantially centrally located on the adjustable cushion 100″, at or adjacent to a surface of the adjustable cushion 100″. As illustrated, the top compartment 16′″ and bottom compartment 17″ may be symmetrically located. Alternatively, the top compartment 16″ and bottom compartment 17′″ may be asymmetrically located.

Though illustrated as substantially oval in shape, each secondary compartment 16″, 18″ (FIG. 6), 16′″, 17′″, 18′″ may have any other appropriate shape (e.g., a circular cylinder, a polygonal prism, etc.). Each secondary compartments 16″, 18″, 16′″, 17′″, 18′″ may provide additional adjustments or further customization to the adjustable cushion 100″, 100′″. In some embodiments, each compartment 16″, 18″, 16′″, 17′″, 18′″ is individually adjustable. In some embodiments, each compartment 16″, 18″, 16′″, 17′″, 18′″ is incorporated into a casing 10″, 10′″ and each compartment 16″, 18″, 16′″, 17′″, 18′″ is accessible via an opening and an optional closure incorporated into the casing 10″, 10′″.

FIG. 7 illustrates an example of a cushioning system 200 that includes an adjustable cushion 100 (e.g., an adjustable pillow, etc.) and a secondary cushion 130. The adjustable pillow 100 may comprise an embodiment of adjustable cushion (e.g., adjustable cushions 100, 100′, 100″, 100′″, etc.) within the scope of this disclosure. The adjustable cushion 100 includes a casing 10 and a fill material 20 (FIGS. 3, 4, and 9). The secondary cushion 130 may include a secondary casing 30 and a fill material 20 within a compartment of the secondary casing 30. The fill material 20 of the secondary cushion 130 may be the same type of fill material as the fill material 20 of the adjustable cushion 100. In some embodiments, the fill material 20 in the secondary cushion 130 is excess fill material 20 that has been removed from the adjustable cushion 100 or may be added to the adjustable cushion 100. The secondary cushion 130 may be used as a throw pillow or an extra cushion.

In some embodiments, the secondary casing 30 of the secondary cushion 130 holds extra fill material 20 (FIGS. 3, 4, and 9). In some embodiments, the secondary casing 30 may be transparent, to enable viewing of the fill material 20 contained therein. In other embodiments, the secondary casing 30 may be decorated with indicia 36. For example, as illustrated, the indicia 36 on the secondary casing 30 may represent a shape or shapes of pieces of the fill material 20 within the compartment of the secondary casing 30 (e.g., heart shaped indicia 36, as illustrated; stars; moons; clouds; etc.).

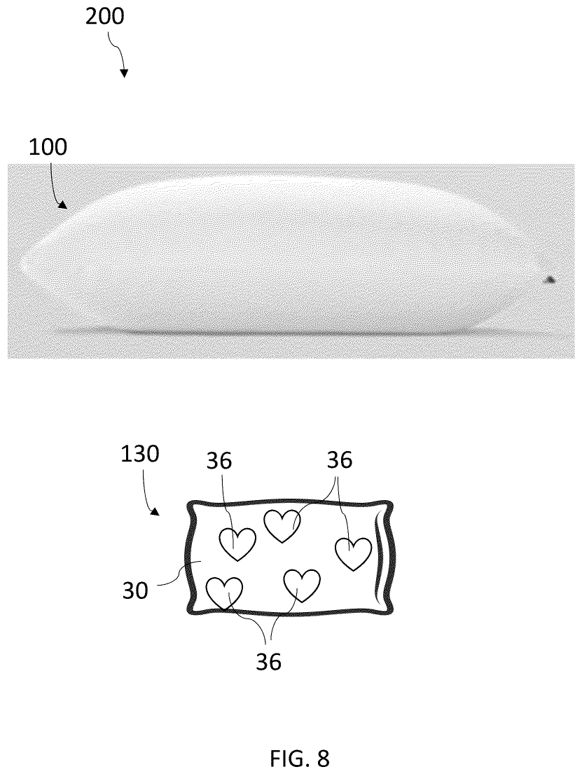

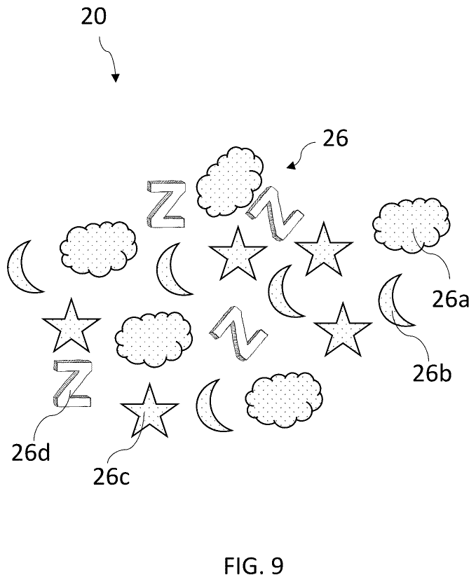

FIG. 9 depicts an embodiment of the fill material 20 for an adjustable cushion 100 (FIG. 1) and/or a cushioning system 200 (FIG. 8). In some embodiments, the fill material 20 is cut or otherwise shaped into any of a variety of shapes 26. The shapes 26 can include any shape. As illustrated, the shapes 26 may include clouds 26a, moons 26b, stars 26c, and/or Zs 26d. In some embodiments, the shapes 26 are chosen to correspond to one or more shapes or objects typically associated with nighttime and/or sleeping (e.g., moons 26b, stars 26c, and Zs 26d, etc.).

In some embodiments, the shapes 26 are chosen to correspond to an intended user of the adjustable pillow 100. For example, when the intended user is a child, the plurality of shapes 26 may include animals, rainbows, cars, trucks, bows, clouds, stars, shooting stars, planets, flowers, or other shapes. When the intended user is an adult, the plurality of shapes 26 may include letters, clouds, polygons, or other shapes.

In addition to including shapes 26, the fill material 20 may be colored. In some embodiments, the fill material 20 is colored in accordance with a theme. For example, the fill material 20 may be colored according to a nighttime or night sky theme, including darker colors such as purples, blues and dark blues, and greys. As another non-limiting example, the fill material 20 may be colored along a dawn or new day theme, including lighter colors such as oranges, pinks, light blues, and yellows. In some embodiments, the fill material 20 may include white fibers mixed or otherwise dispersed throughout individual pieces of foam, where the white fibers can impart an appearance of clouds to support the night sky (e.g., midnight-blue pieces of foam, etc.) and/or new day (e.g., sky-blue pieces of foam, etc.) themes.

In some embodiments, the fill material 20 is a foam material. In some embodiments, the fill material 20 is a responsive foam material. Examples of fill materials that may be used as the fill material 20 are outlined and described in U.S. Patent Application Publication No. US 2020/0390247 A1, titled CUSHION COVERS FOR CUSHIONS and filed on Jun. 15, 2020, and U.S. Patent Application Publication No. US 2022/0142383 A1, titled, PILLOW WITH VARIABLE CUSHIONING CHARACTERISTICS and filed on Nov. 8, 2021, the entire disclosures of which are hereby incorporated herein. In some embodiments, the fill material 20 includes a fiber material woven, mixed in, or otherwise dispersed throughout the foam material. In some embodiments, the fiber material provides additional comfort and/or support to the foam material. In some embodiments, the fiber material or properties of the fiber material cause the foam material (and the shapes cut from the fill material 20) to cling to themselves when the adjustable pillow 100 is handled. This allows the fill material 20 to stay together as a mass when, for example, a user has placed their head on the adjustable pillow 100. That is, the fill material 20 maintains a platform for the user to rest their head on. In contrast, the fill of many conventional pillows spreads out when handled and does not provide a comfortable platform when a user is resting their head on the pillow.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. An adjustable pillow comprising:
a casing having an opening; and
a first compartment and a second compartment, where the first compartment may be larger in volume than the second compartment,
each compartment accessible from the opening, the second compartment extending along a length of a side of the casing and occupying at least a portion of the first compartment.

2. The adjustable pillow of claim 1, wherein the responsive foam has a midnight sky color.

3. The adjustable pillow of claim 1, wherein the responsive foam has a sky-blue color.

4. The adjustable pillow of claim 1, wherein the responsive foam has a purple color.

5. The adjustable pillow of claim 1, wherein the fiber fill has a white color.

6. The adjustable pillow of claim 5, wherein the fiber fill appears as clouds dispersed throughout a midnight sky colored responsive foam.

7. The adjustable pillow of claim 5, wherein the white colored fiber fill appears as clouds dispersed throughout a new day colored responsive foam.

8. The adjustable pillow of claim 5, wherein the white colored fiber fill appears as clouds dispersed throughout a purple-colored responsive foam.

9. The adjustable pillow of claim 1, further comprising:
additional fill material to be added to the casing to thereby adjust a comfort level of the adjustable pillow.

10. The adjustable pillow of claim 1, wherein the casing comprises at least one layer of an elastomeric material.

11. The adjustable pillow of claim 1, wherein the second compartment comprises part of a neck support.

12. The adjustable pillow of claim 1, further comprising:
a fill material within the first compartment and the second compartment, a firmness and/or a loft of the adjustable pillow being adjustable by adding the fill material to the first compartment and/or the second compartment and/or removing the fill material from the first compartment and/or the second compartment.

13. The adjustable pillow of claim 12, wherein the fill material comprises:
a responsive foam cut into at least one shape; and
a fiber fill mixed with the responsive foam to increasing a comfort of the responsive foam and/or cause pieces of the responsive foam from clinging to each other.

14. The adjustable pillow of claim 1, further comprising:
a third compartment positioned adjacent to a surface of the adjustable pillow.

15. An adjustable cushion system comprising:
an adjustable cushion comprising:
a casing having an opening providing access to a primary compartment and at least one secondary compartment;
a fill material within the first compartment and the second compartment; and
a secondary cushion comprising:
a second casing having an opening; and
the fill material within the second casing,
a firmness and/or a loft of the adjustable cushion being adjustable via:
addition of added fill material from the secondary cushion to the primary compartment and/or the secondary compartment of the casing of the adjustable cushion; or
removal of removed fill material from the primary compartment and/or the secondary compartment of the casing of the adjustable cushion and placement of the removed fill material in the second casing of the secondary cushion.

16. The adjustable cushion system of claim 15, wherein the secondary cushion comprises a decorative pillow.

17. The adjustable cushion system of claim 15, wherein a height of the adjustable cushion ranges from about 4 inches to about 8 inches.

18. The adjustable cushion system of claim 15, wherein the casing of the adjustable cushion comprises at least one layer of an elastomeric grid.

19. The adjustable cushion system of claim 18, wherein the elastomeric grid comprises a hexagonal grid.

20. The adjustable cushion system of claim 15, wherein the primary compartment of the adjustable cushion has a first firmness and the secondary compartment of the adjustable cushion has a second firmness that differs from the first firmness.
